(19) United States
(12) Patent Application Publication
(10) Pub. No.: US 2023/0384489 A1
(43) Pub. Date: Nov. 30, 2023

(54) METASURFACE-MANIPULATED EMISSION FROM A PARTIALLY SPATIALLY COHERENT SOURCE

(71) Applicant: University of Rochester, Rochester, NY (US)

(72) Inventors: Tanya Malhotra, Robbinsdale, MN (US); Anurag Tyagi, Mill Creek, WA (US); James Ronald Bonar, Redmond, WA (US); Quang Minh Quyen Nguyen, Rochester, NY (US); Kevin Liang, Forest Hills, NY (US); Anthony Nickolas Vamivakas, Brighton, NY (US)

(21) Appl. No.: 18/202,548

(22) Filed: May 26, 2023

Related U.S. Application Data
(60) Provisional application No. 63/346,431, filed on May 27, 2022.

(51) Int. Cl. G02B 5/00; G02B 5/30; G02F 1/29

(52) U.S. Cl. CPC G02B 5/008; G02B 5/3008; G02B 27/0172; G02F 1/29; G02B 5/3058

(57) ABSTRACT

A system includes a source configured to emit partially spatially coherent light and a metasurface located proximate to a light emitting surface of the source, where the metasurface is configured to modify at least one property of the emitted light. Modifiable properties include phase, amplitude, directionality, far field profile, and polarization. The metasurface may be passive or active. An active metasurface may be controlled using an input such as applied voltage, temperature, and mechanical force. The system may be configured to provide coherent illumination.

### CROSS-REFERENCE TO RELATED APPLICATION

This application claims the benefit of priority under 35 U.S.C. § 119(e) of U.S. Provisional Application No. 63/346,431, filed May 27, 2022, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates the co-integration of multiple coherent metasurfaces with a partially spatially coherent light emitting diode (LED) according to some embodiments.

FIG. 2 shows example cross-sectional architectures of systems having a metasurface located proximate to a light emitting surface of an LED according to certain embodiments.

FIG. 3 illustrates the co-integration of multiple coherent metasurfaces with a partially spatially coherent vertical cavity surface emitting laser (VCSEL) according to some embodiments.

FIG. 4 shows example cross-sectional architectures of systems having a metasurface located proximate to a light emitting surface of a vertical cavity surface emitting laser (VCSEL) according to certain embodiments.

FIG. 5 illustrates multi-plane light conversion (MPLC)-based sorting of partially spatially coherent light into discrete coherent modes according to various embodiments.

FIG. 6 shows a multilayer architecture including plural metasurfaces configured to sort and modify light emitted from a partially spatially coherent emitter according to some embodiments.

FIG. 7 shows a further multilayer architecture including plural metasurfaces configured to sort and modify light emitted from a partially spatially coherent emitter according to some embodiments.

FIG. 8 is a perspective view showing a single planar metasurface configured to manipulate the directionality of partially spatially coherent light according to certain embodiments.

FIG. 9 illustrates an array of coherent metasurfaces configured to independently modify each of a plurality of sorted coherent modes of emitted partially coherent light according to some embodiments.

FIG. 10 illustrates elements of an example system for producing and characterizing partially spatially coherent light according to some embodiments.

FIG. 11 illustrates the application of coherent mode decomposition techniques to design various metasurface functionalities according to some embodiments.

FIG. 12 illustrates modeled data associated with the application of coherent mode decomposition theory according to certain embodiments.

FIG. 13 is an illustration of exemplary augmented-reality glasses that may be used in connection with embodiments of this disclosure.

FIG. 14 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure relates generally to the reconfiguration of the light output from a partially coherent light source, and more particularly to the efficient design and implementation of metasurfaces to manipulate one or more attributes of partially spatially coherent light. Example attributes include phase, amplitude, directionality, far-field profile, polarization, etc.

As used herein, “spatial coherence” may refer to the phase relationship within a propagating beam of light at different points in space. In some systems, like states may extend over one or two dimensions. By way of example, spatial coherence may describe the ability for two points in space, e.g., along the extent of a propagating wave, to interfere when averaged over time. In accordance with various embodiments, “partially spatially coherent” light may be characterized by a frequent and random change in the phase between photons as a function of distance along a propagating wave.

A “metasurface” may include structured or unstructured subwavelength-scale features disposed on a supporting substrate or within a supporting matrix. Example metasurfaces may include multi-resonance or gap-surface plasmon (GSP) structures, Pancharatnam-Berry phase metasurfaces, and Huygens' metasurfaces. A metasurface may include hyperbolic metamaterials (HMMs), for example. The composition, design, and configuration of the constituent nanoscale features (i.e., metaatoms), optionally in conjunction with one or more functional materials, may be used to impart customized phase, amplitude, directionality, and/or far field profile to incident light, and may be extended to include polarization conversion and wavefront shaping, for example. Various embodiments thus relate to the design of metasurfaces for the efficient manipulation of partially spatially coherent light.

A system may include a source configured to emit partially spatially coherent light and a metasurface located proximate to a light emitting surface of the source, where the metasurface is configured to modify at least one property of the emitted light. Such a system may be incorporated into a head-mounted display.

By way of example, and in accordance with various embodiments, an integrated metasurface may condense the far field profile of a source of partially spatially coherent light and accordingly improve the coupling or collection efficiency of emitted light into an optical element such as a lens or a waveguide. In this regard, it is known that the far field profile of light emitted from a source having a smaller output area may be more diffuse than light emitted from a larger source. Applicants have shown that an integrated metasurface may improve the collection optics of a partially spatially coherent source, and in particular a source that may be characterized by a lateral dimension of less than approximately 50 micrometers, e.g., less than 50, 40, 30, 20, 10, 5, 2, 1, 0.5, 0.2, or 0.1 micrometers, including ranges between any of the foregoing values.

Example sources may include one or more multi-mode lasers, one or more vertical cavity surface emitting lasers (VCSELs), or one or more light emitting diodes (LEDs), including regular or irregular arrays thereof. In some systems, the source may have a compact light emitting surface. Particular examples include an LED source having a light emitting surface characterized by a lateral dimension of less than approximately 10 micrometers, less than approximately 5 micrometers, or less than approximately 2 micrometers. Further examples include a VCSEL source having a light emitting surface characterized by a lateral dimension of less than approximately 50 micrometers. In some embodiments, each addressable element (i.e., pixel) within a display device may have a corresponding metasurface. The source may emit light within the visible spectrum, and the emitted light may be continuous or pulsed. As used herein, the terms “source” or “light source” and “emitter” may be used interchangeably.

The metasurface may include one or more surfaces. In particular embodiments, the metasurface may include a multiplexed 2D array of coherent metasurfaces. As used herein, and in accordance with some examples, a “coherent metasurface” may be configured to transform an incident waveform into a desired waveform (e.g., by changing a direction of propagation) by spatially varying scattering along the surface. In further embodiments, the metasurface may include a multilayer, i.e., 3D architecture. For instance, a system may include a plurality of coherent metasurfaces, where each coherent metasurface is configured to modify a property of a selected mode of emitted light.

A metasurface may include dielectric or electrically conductive materials, and may be passive or active. An active metasurface may be dynamically reconfigurable through the application of a voltage, temperature, or mechanical force. A metasurface may be located in close proximity to the light emitting surface of a source. In some systems, a distance between the light emitting surface and the metasurface may be less than approximately 20λ, where λ is the wavelength of the incident light. In particular embodiments, a distance between the light emitting surface and the metasurface may be less than approximately 10 micrometers.

According to further embodiments, a method may include emitting partially spatially coherent light from a source, and passing the emitted light through a metasurface located proximate to the source, such that the metasurface modifies at least one property of the emitted light.

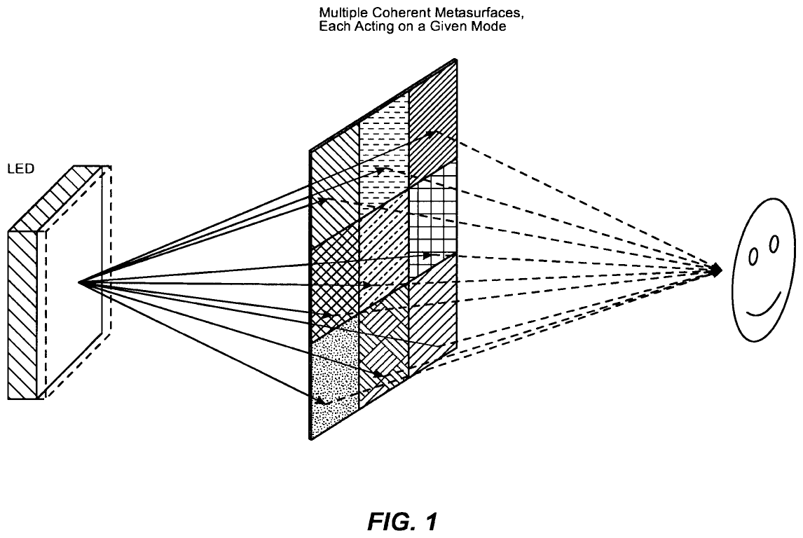

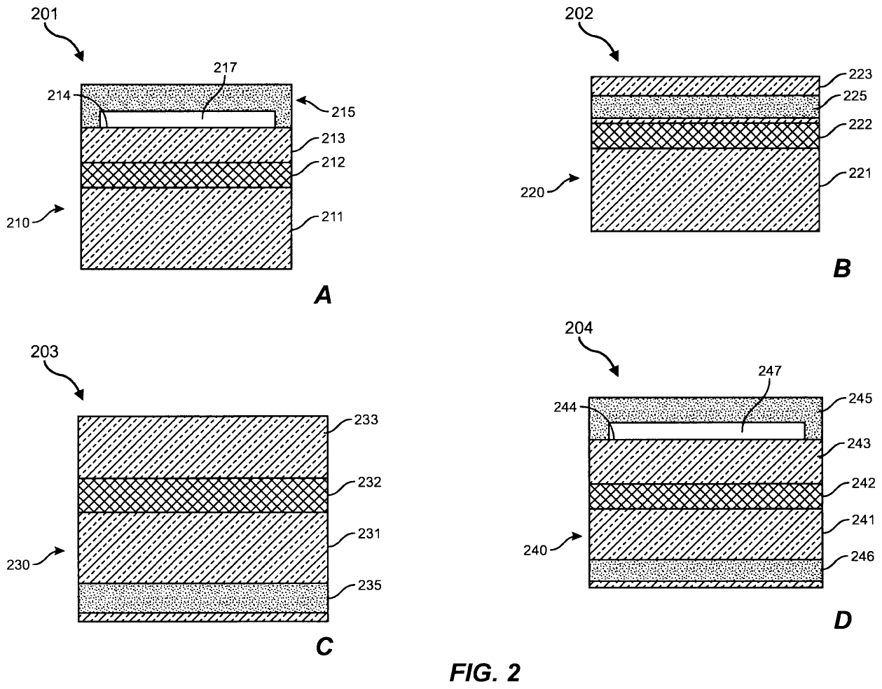

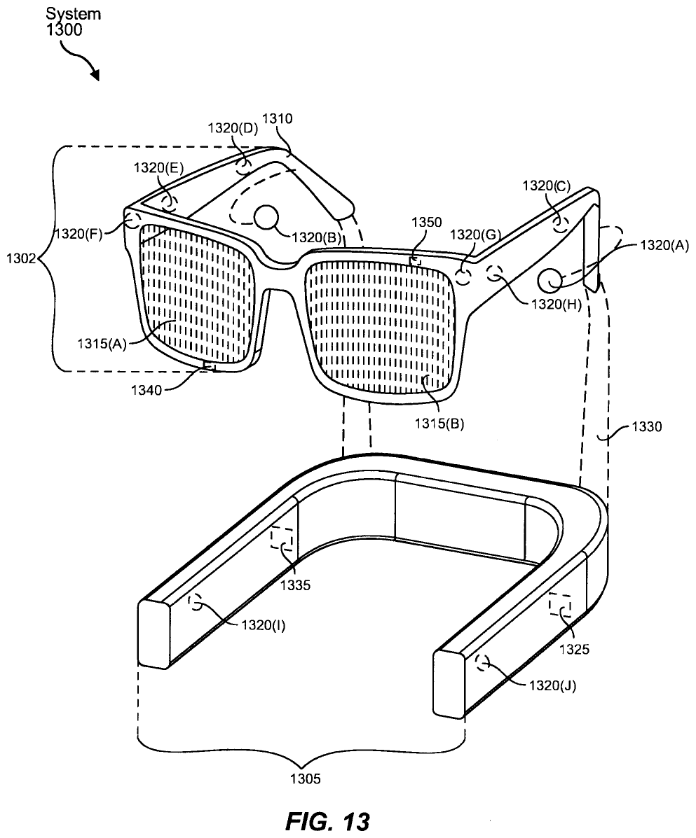

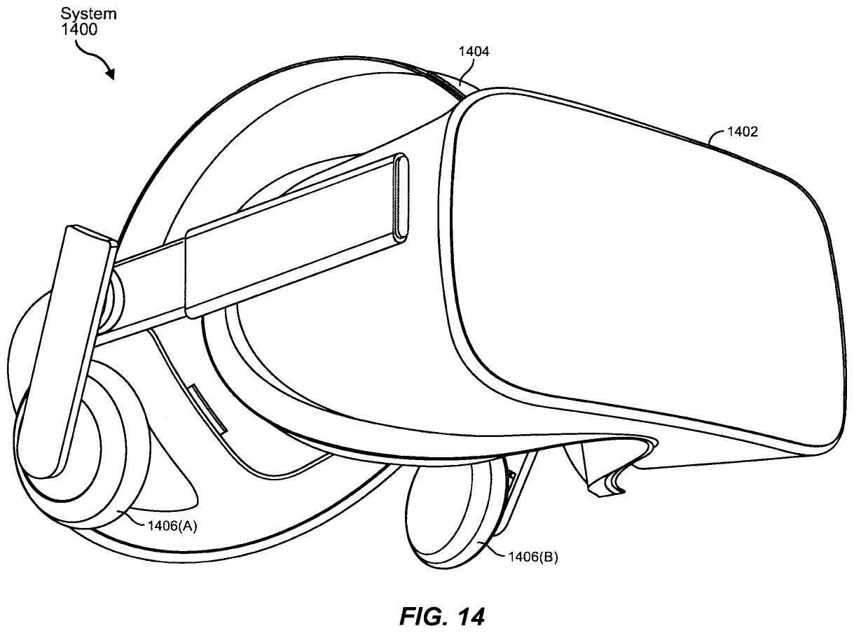

The following will provide, with reference to FIGS. 1-14, a detailed description of structures and methods for manipulating the light emission from a partially spatially coherent emitter using metasurfaces. The discussion associated with FIGS. 1-12 includes a description of systems for metasurface-based manipulation of one or more properties of partially spatially coherent light. The discussion associated with FIGS. 13 and 14 relates to exemplary virtual reality and augmented reality devices that may include one or more metasurfaces configured to augment one or more properties of partially spatially coherent light.

Referring to FIG. 1, shown schematically is an example system including a light emitting diode and a plurality of coherent metasurfaces located proximate to an output surface of the LED. In the illustrated embodiment, the metasurfaces are arranged in a 3×3 array, where a repeating configuration of metaatoms may be unique to and define each metasurface. Although a 3×3 array is illustrated, different configurations and a lesser or greater number of metasurfaces are contemplated. The metasurfaces may be oriented in a direction orthogonal to a direction of light propagation and may be configured to modify a distinct mode of the LED's partially spatially coherent output. Various device configurations that include an LED and a metasurface are illustrated in the cross-sectional views of FIG. 2.

Referring to FIG. 2A, a device 201 includes an LED 210 and a plurality of metasurfaces 215 located proximate to an output surface 214 of the LED 210. The LED 210 includes, from bottom to top, a p-type semiconductor layer 211, emissive layer 212, and an n-type semiconductor layer 213. As shown in the illustrated embodiment, the output surface 214 of LED 210 and the metasurfaces 215 are separated by an air gap 217.

Referring to FIG. 2B and device 202, an LED 220 includes a p-type semiconductor layer 221, emissive layer 222, and an n-type semiconductor layer 223. Metasurfaces 225 are incorporated into one of the device layers, i.e., n-type semiconductor layer 223.

Referring to FIG. 2C and device 203, an LED 230 includes a p-type semiconductor layer 231, emissive layer 232, and an n-type semiconductor layer 233. Metasurfaces 235 are incorporated into one of the device layers, i.e., p-type semiconductor layer 231.

Referring to FIG. 2D, a device 204 includes an LED 240 having, from bottom to top, a p-type semiconductor layer 241, emissive layer 242, and an n-type semiconductor layer 243. First metasurfaces 245 are located proximate to an output surface 244 of the LED 240, and separated therefrom by an air gap 247. Second metasurfaces 246 are incorporated into the p-type semiconductor layer 241 of LED 240.

In some LEDs, the emissive layers 212, 222, 232, 242 may include a quantum well, e.g., multiple quantum wells. In some embodiments, p-type semiconductor layers 211, 221, 231, 241 may be configured as hole transport layers, and n-type semiconductor layers 213, 223, 233, 243 may be configured as electron transport layers. By way of example, an inorganic LED device may include InGaN quantum wells, and p-type and n-type GaN hole and electron transport layers. In FIGS. 2A-2D, top and bottom electrodes are omitted for clarity. In further embodiments, the emissive layers 212, 222, 232, 242 may include one or more organic molecules, or light-emitting fluorescent dyes or dopants, which may be dispersed in a suitable matrix.

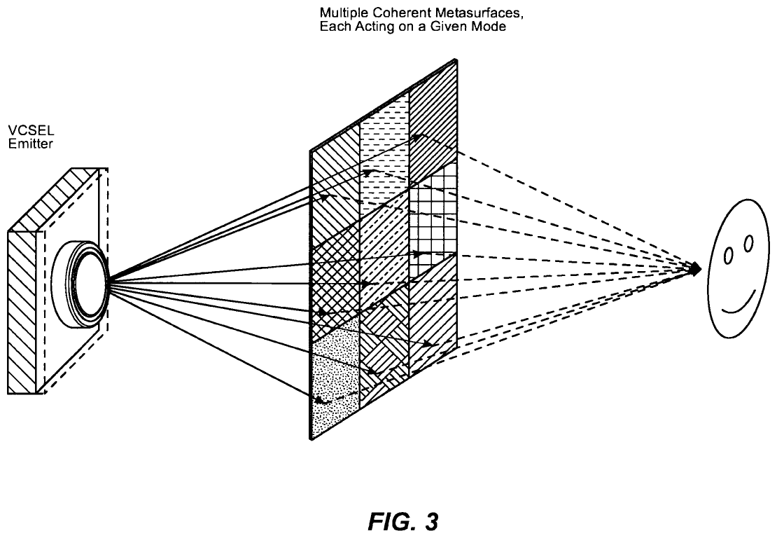

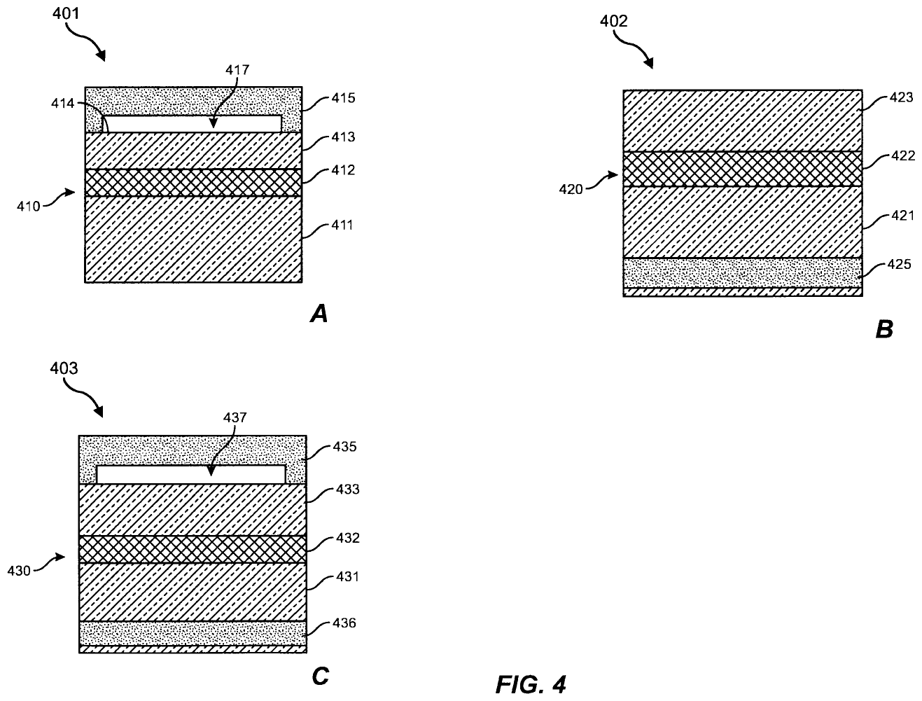

Shown schematically in FIG. 3 is a further example system that includes a vertical cavity surface emitting laser (VCSEL) and a plurality of coherent metasurfaces located proximate to an output surface of the VCSEL. In the illustrated embodiment, the metasurfaces are arranged in a 3×3 array, where a repeating configuration of metaatoms may be unique to and define each metasurface. Each of the metasurfaces may be oriented in a direction orthogonal to a direction of light propagation and may be configured to modify a distinct mode of the VCSEL output. Example device configurations that include a VCSEL (or VCSEL array) and a metasurface are illustrated in FIG. 4.

Referring to FIG. 4A, a device 401 includes a vertical cavity surface emitting laser 410 and a plurality of metasurfaces 415 located proximate to an output surface 414 of the VCSEL 410. The VCSEL 410 includes, from bottom to top, a first distributed Bragg reflector (DBR) mirror 411, an emissive layer 412, and a second distributed Bragg reflector (DBR) mirror 413. As shown in the illustrated embodiment, the output surface 414 of VCSEL 410 and the metasurfaces 415 are separated by an air gap 417.

Referring to FIG. 4B and device 402, a vertical cavity surface emitting laser 420 includes a first DBR mirror stack 421, an emissive layer 422 overlying first DBR mirror stack 421, and a second DBR mirror stack 423 overlying emissive layer 422. Metasurfaces 425 are incorporated into first DBR mirror stack 421.

Referring to FIG. 4C, a device 403 includes a vertical cavity surface emitting laser 430 having a first DBR mirror stack 431, an emissive layer 432 overlying first DBR mirror stack 431, and a second DBR mirror stack 433 overlying emissive layer 432. In the illustrated embodiment, a first plurality of metasurfaces 435 are located proximate to second DBR mirror stack 433 and are separated therefrom by an air gap 437, and a second plurality of metasurfaces 436 are incorporated into first DBR mirror stack 431. In some VCSELs, the emissive layers 412, 422, 432 may include a quantum well.

According to some embodiments, the principles of coherent mode decomposition (CMD) may be used in the manipulation of partially spatially coherent light. In accordance with some embodiments, the CMD-based manipulation of partially spatially coherent light may include (i) decomposing partially spatially coherent light into at least two discrete coherent modes, and (ii) interacting each of the at least two discrete coherent modes with a respective metasurface configured for each respective discrete coherent mode.

Coherent mode decomposition refers to the act of decomposing partially spatially coherent light into its respective coherent modes. Without wishing to be bound by theory, coherence properties of input electromagnetic fields may be described using the cross spectral density (CSD) matrix, [symbol] ᵢ(r₁,r₂)= [symbol] E*ᵢ(r₁)⊗Eᵢ(r₂) [symbol] .

The CSD matrix corresponding to the input fields (i.e., light emitted by an LED) may be decomposed into coherent modes using the following equation, [symbol] ᵢ(r₁,r₂)=ΣₙλₙE*ₙ(r₁)⊗Eₙ(r₂)=Σₙλₙ [symbol] ₙ(r₁,r₂).

In some embodiments, a partially spatially coherent light source is employed which has at least two discrete coherent modes identifiable by coherent mode decomposition which each provide at least 5% of the total power of the partially spatially coherent light source. In further embodiments, a partially spatially coherent light source is employed which has at least two discrete coherent modes identifiable by coherent mode decomposition which each provide at least 10% of the total power of the partially spatially coherent light source.

In various aspects of such embodiments, the light source employed may be selected to have 20 or fewer discrete coherent modes which cumulatively provide at least 50% of the total power of the partially spatially coherent light source, or 10 or fewer discrete coherent modes cumulatively providing at least 50% of the total power of the partially spatially coherent light source, or 5 or fewer discrete coherent modes cumulatively providing at least 50% of the total power of the partially spatially coherent light source.

In further aspects of such embodiments, the light source employed may be selected to have no more than 10 discrete coherent modes that each provide at least 5% of the total power of the partially spatially coherent light source, or no more than 5 discrete coherent modes each providing at least 10% of the total power of the partially spatially coherent light source, or no more than 5 discrete coherent modes each providing at least 5% of the total power of the partially spatially coherent light source.

Employing partially coherent light sources meeting such identified ranges of discrete coherent modes may be achieved, e.g., by limiting the size of the light emitting surface of the light source. Use of light emitting sources with such limited numbers of discrete coherent modes supplying a significant percentage of the total power of a partially spatially coherent light source may advantageously reduce the number of respective metasurfaces required for efficiently interacting with a partially coherent light source.

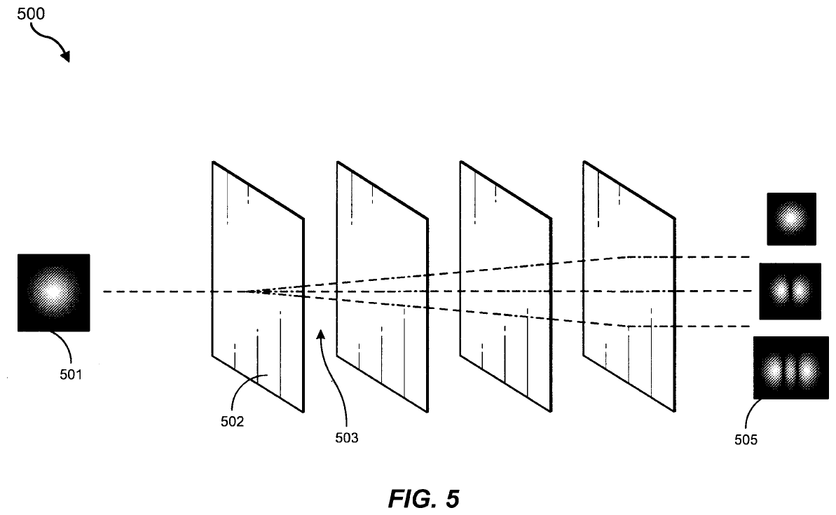

A multi-plane light converter (MPLC) may be used to provide spatial separation of coherent modes. It has been shown that unitary transformations may be achieved using a combination of local phase control and Fourier transforms. Accordingly, an MPLC may be implemented as a spatial mode multiplexing tool that is configured to sort and separate coherent modes from a non-coherent source. That is, an MPLC may implement any spatial change of basis using successive phase masks that are separated by free-space propagation. In one example, and with reference to FIG. 5, during operation of MPLC 500, input field 501 may be partially spatially coherent and may propagate through plural phase planes 502 as well as via free space 503 where coherent modes 505 may be sorted at the output plane. Each phase plane 502 may be oriented in a direction orthogonal or substantially orthogonal to a direction of light propagation.

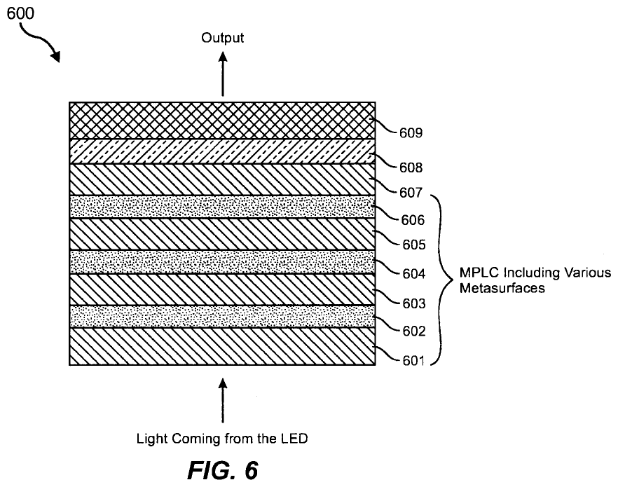

Referring to FIG. 6, illustrated is an example implementation of a multilayer stack of metasurfaces that is configured to deconstruct and manipulate partially spatially coherent light in conjunction with a multi-plane light converter (MPLC). One or more layers within device 600 may be configured as MPLC layers, metasurface layers, and/or free-space propagation layers. For example, layers 601-607 may include MPLC layers that form a mode sorter adapted to demultiplex partially spatially coherent light into coherent modes and direct each mode along a mode-specific direction. In the illustrated embodiment, layers 602, 604, 606 may include metasurfaces that are configured to impart a desired phase response within the MPLC, whereas layers 601, 603, 605, and 607 may include an un-patterned surface for free space propagation. Layer 608 may include a further metasurface that is configured to manipulate each of the coherent modes sorted by the MPLC. Layer 609 may be configured to recombine the plural coherent modes and direct them along a desired direction.

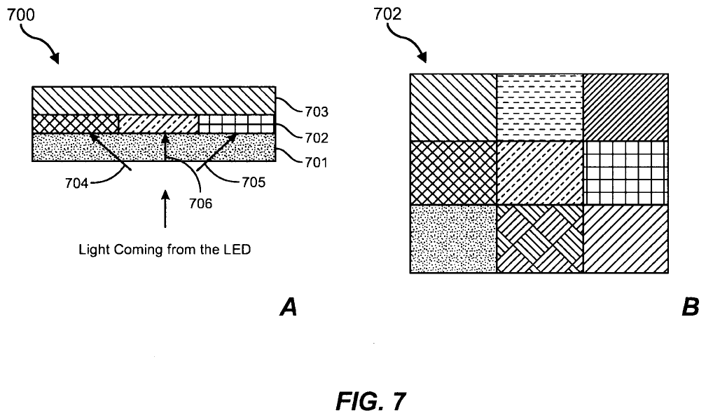

A further example MPLC-based system for deconstructing and manipulating partially spatially coherent light is shown in FIG. 7. Referring to FIG. 7A, system 700 may include a mode sorter 701, such as a MPLC (multi plane light converter) configured to demultiplex partially spatially coherent light into coherent modes and direct each mode along different directions 704, 705, 706. A metasurface 702 may include a 2D array of metasurfaces configured to respectively manipulate an incident coherent mode. Layer 703 may be configured to recombine the plural coherent modes and direct them along a desired direction. A plan view of metasurface 702 showing 9 discrete metasurfaces, each configured to interact with a single coherent mode, is shown in FIG. 7B.

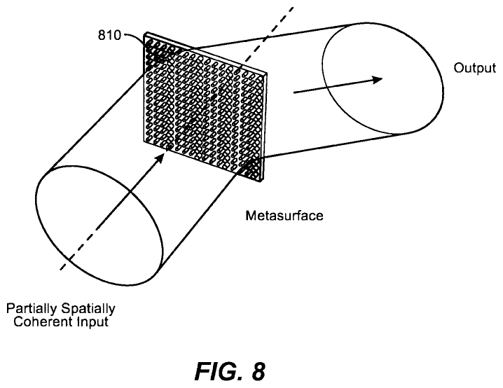

Referring to FIG. 8, illustrated is a single planar metasurface 810 that may be configured to manipulate partially spatially coherent light, optionally without spatially separating the non-coherent light input into its coherent modes.

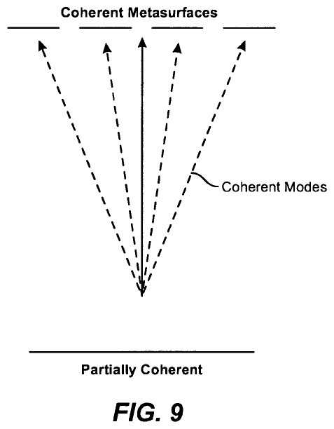

Referring to FIG. 9, shown schematically is a method for manipulating light emission from a partially spatially coherent light source. Partially spatially coherent light may be initially sorted into its constituent coherent modes (e.g., using a multi plane light converter). One or more properties of each of the coherent modes may be manipulated by directing individual coherent modes to a corresponding metasurface within an array of metasurfaces. In particular embodiments, each metasurface may be configured to interact with a single coherent mode only. That is, a metasurface may include a composite of mode-specific regions that are individually configured to modify a particular coherent mode.

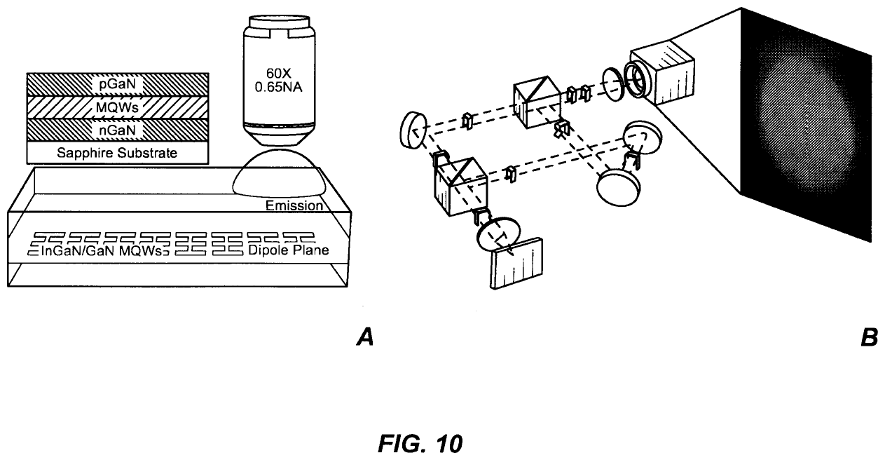

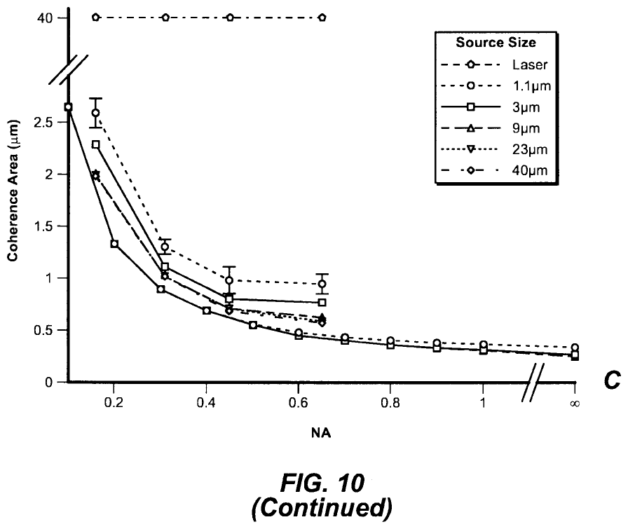

Example devices and their operating characteristics are illustrated in FIG. 10. An example LED device for producing partially spatially coherent light is shown schematically in FIG. 10A. A schematic illustration of a Mach-Zehnder interferometer for measuring spatial coherence in different LED outputs is shown in FIG. 10B. FIG. 10C shows the variation of spatial coherence area with source size and collection angle.

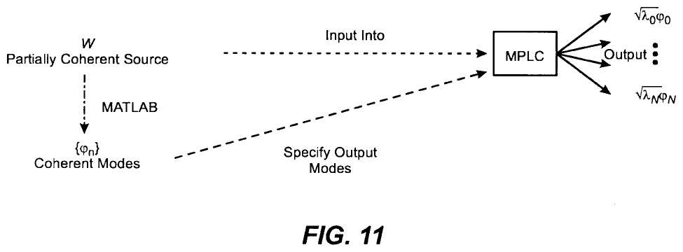

Referring to FIG. 11, shown schematically are generalized principles for using coherent mode decomposition to design metasurface functionalities to manage one or more of phase (directionality), intensity, polarization, and coherence in a source of non-coherent light.

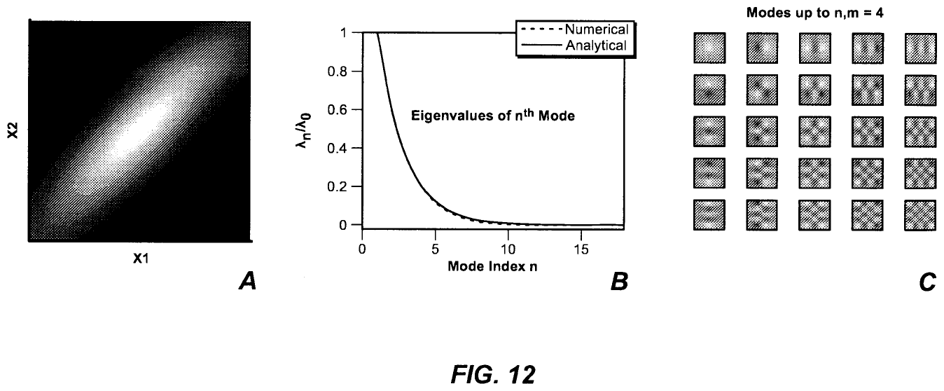

Coherent mode decomposition results are shown in FIG. 12. FIG. 12A shows the cross spectral density (CSD) function for a partially spatially coherent light source. FIG. 12B shows simulated modal weights for various coherent modes present in the partially spatially coherent light source. FIG. 12C shows images of the first 16 modes.

As disclosed herein, an engineered metasurface is located proximate to the output of a partially spatially coherent emitter. The metasurface may be multiplexed in plane and/or as a stack, and is configured to manipulate one or more property of an emitted wave, including its phase, amplitude, directionality, far-field profile, polarization, etc.

The metasurface may be passive or active and plural metasurfaces may be adapted to interact with each of a plurality of modes output by the emitter. A passive metasurface may include a grating or token architecture, for example, or a layered structure. An active metasurface may be controllable using one or more of an applied voltage, temperature, or mechanical force. A metasurface may include a dielectric material or, in some examples, the metasurface may be electrically conductive and function also as an electrode.

In particular embodiments, each of a plurality of metasurfaces may be configured to interact with a respective coherent mode of a partially spatially coherent output. The emitter may include a light emitting diode (LED) or LED array, a vertical cavity surface emitting laser (VCSEL) or VCSEL array, or a multi-mode laser, for example.

In one example, the metasurface may be located adjacent to a light emitting surface of a light emitting diode or optionally separated therefrom by an air gap, where the LED may have a lateral dimension of less than approximately 10 micrometers and the metasurface may be disposed within approximately 10 micrometers of the light emitting surface. According to a further example, the metasurface may be positioned within approximately 10 micrometers of a vertical cavity surface emitting laser having a lateral dimension of less than approximately 50 micrometers. The emitter-integrated metasurface may be configured to provide coherent illumination.

### Example Embodiments

Example 1: A system includes a source configured to emit partially spatially coherent light and a metasurface located proximate to a light emitting surface of the source, where the metasurface is configured to modify at least one property of the emitted light.

Example 2: The system of Example 1, where the source includes a multi-mode laser, a vertical cavity surface emitting laser (VCSEL), or a light emitting diode (LED).

Example 3: The system of any of Examples 1 and 2, where the source includes an array of vertical cavity surface emitting lasers.

Example 4: The system of any of Examples 1-3, where the metasurface includes a multiplexed 2D array of coherent metasurfaces.

Example 5: The system of any of Examples 1-4, where the metasurface includes a multilayer architecture.

Example 6: The system of any of Examples 1-5, including a plurality of coherent metasurfaces, where each coherent metasurface is configured to modify the at least one property of a respective selected mode of the emitted light.

Example 7: The system of any of Examples 1-6, where the metasurface includes a dielectric material.

Example 8: The system of any of Examples 1-7, where the metasurface includes an electrically conductive material.

Example 9: The system of any of Examples 1-8, where the metasurface is configured to be transformed using an input selected from applied voltage, temperature, and mechanical force.

Example 10: The system of any of Examples 1-9, where a distance between the light emitting surface and the metasurface is less than approximately 10 micrometers.

Example 11: The system of any of Examples 1-10, where a lateral dimension of the light emitting surface is less than approximately 50 micrometers.

Example 12: The system of any of Examples 1-11, where a lateral dimension of the light emitting surface is less than approximately 10 micrometers.

Example 13: The system of any of Examples 1-12, where the at least one property is selected from phase, amplitude, directionality, far field profile, and polarization.

Example 14: A head-mounted display including the system of any of Examples 1-13.

Example 15: A method includes emitting partially spatially coherent light from a source, and passing the emitted light through a metasurface located proximate to the source, where the metasurface modifies at least one property of the emitted light.

Example 16: The method of Example 15, where the emitted light is continuous.

Example 17: The method of Example 15, where the emitted light is pulsed.

Example 18: The method of any of Examples 15-17, where the at least one property is selected from phase, amplitude, directionality, far field profile, and polarization.

Example 19: A device includes a light source configured to emit partially spatially coherent light, and a plurality of coherent metasurfaces located proximate to a light emitting surface of the light source.

Example 20: The device of Example 19, where each coherent metasurface is configured to modify at least one property of a respective mode of the emitted light.

Example 21: The device of any of Examples 19 and 20, where the partially spatially coherent light is decomposable into at least two discrete coherent modes such that a respective coherent metasurface is configured to modify at least one property of the emitted light for each discrete coherent mode.

Example 22: The device of any of Examples 19-21, where the partially spatially coherent light has at least two discrete coherent modes identifiable by coherent mode decomposition that each provide at least 5% of the total power of the partially spatially coherent light source.

Example 23: The device of any of Examples 19-22, where the partially spatially coherent light has at least two discrete coherent modes identifiable by coherent mode decomposition that each provide at least 10% of the total power of the partially spatially coherent light source.

Example 24: The device of any of Examples 19-23, where the partially spatially coherent light has 20 or fewer discrete coherent modes that cumulatively provide at least 50% of the total power of the partially spatially coherent light source.

Example 25: The device of any of Examples 19-24, where the partially spatially coherent light has 10 or fewer discrete coherent modes that cumulatively provide at least 50% of the total power of the partially spatially coherent light source.

Example 26: The device of any of Examples 19-25, where the partially spatially coherent light has no more than 10 discrete coherent modes that each provide at least 5% of the total power of the partially spatially coherent light source.

Example 27: The device of any of Examples 19-26, where the partially spatially coherent light has no more than 5 discrete coherent modes each providing at least 5% of the total power of the partially spatially coherent light source.

Example 28: The device of any of Examples 19-27, where the partially spatially coherent light has no more than 5 discrete coherent modes each providing at least 10% of the total power of the partially spatially coherent light source.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1300 in FIG. 13) or that visually immerses a user in an artificial reality (such as, e.g., virtual-reality system 1400 in FIG. 14). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 13, augmented-reality system 1300 may include an eyewear device 1302 with a frame 1310 configured to hold a left display device 1315(A) and a right display device 1315(B) in front of a user's eyes. Display devices 1315(A) and 1315(B) may act together or independently to present an image or series of images to a user. While augmented-reality system 1300 includes two displays, embodiments of this disclosure may be implemented in augmented-reality systems with a single NED or more than two NEDs.

In some embodiments, augmented-reality system 1300 may include one or more sensors, such as sensor 1340. Sensor 1340 may generate measurement signals in response to motion of augmented-reality system 1300 and may be located on substantially any portion of frame 1310. Sensor 1340 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1300 may or may not include sensor 1340 or may include more than one sensor. In embodiments in which sensor 1340 includes an IMU, the IMU may generate calibration data based on measurement signals from sensor 1340. Examples of sensor 1340 may include, without limitation, accelerometers, gyroscopes, magnetometers, other suitable types of sensors that detect motion, sensors used for error correction of the IMU, or some combination thereof.

In some examples, augmented-reality system 1300 may also include a microphone array with a plurality of acoustic transducers 1320(A)-1320(J), referred to collectively as acoustic transducers 1320. Acoustic transducers 1320 may represent transducers that detect air pressure variations induced by sound waves. Each acoustic transducer 1320 may be configured to detect sound and convert the detected sound into an electronic format (e.g., an analog or digital format). The microphone array in FIG. 13 may include, for example, ten acoustic transducers: 1320(A) and 1320(B), which may be designed to be placed inside a corresponding ear of the user, acoustic transducers 1320(C), 1320(D), 1320(E), 1320(F), 1320(G), and 1320(H), which may be positioned at various locations on frame 1310, and/or acoustic transducers 1320(I) and 1320(J), which may be positioned on a corresponding neckband 1305.

In some embodiments, one or more of acoustic transducers 1320(A)-(J) may be used as output transducers (e.g., speakers). For example, acoustic transducers 1320(A) and/or 1320(B) may be earbuds or any other suitable type of headphone or speaker.

The configuration of acoustic transducers 1320 of the microphone array may vary. While augmented-reality system 1300 is shown in FIG. 13 as having ten acoustic transducers 1320, the number of acoustic transducers 1320 may be greater or less than ten. In some embodiments, using higher numbers of acoustic transducers 1320 may increase the amount of audio information collected and/or the sensitivity and accuracy of the audio information. In contrast, using a lower number of acoustic transducers 1320 may decrease the computing power required by an associated controller 1350 to process the collected audio information. In addition, the position of each acoustic transducer 1320 of the microphone array may vary. For example, the position of an acoustic transducer 1320 may include a defined position on the user, a defined coordinate on frame 1310, an orientation associated with each acoustic transducer 1320, or some combination thereof.

Acoustic transducers 1320(A) and 1320(B) may be positioned on different parts of the user's ear, such as behind the pinna, behind the tragus, and/or within the auricle or fossa. Or, there may be additional acoustic transducers 1320 on or surrounding the ear in addition to acoustic transducers 1320 inside the ear canal. Having an acoustic transducer 1320 positioned next to an ear canal of a user may enable the microphone array to collect information on how sounds arrive at the ear canal. By positioning at least two of acoustic transducers 1320 on either side of a user's head (e.g., as binaural microphones), augmented-reality device 1300 may simulate binaural hearing and capture a 3D stereo sound field around about a user's head. In some embodiments, acoustic transducers 1320(A) and 1320(B) may be connected to augmented-reality system 1300 via a wired connection 1330, and in other embodiments acoustic transducers 1320(A) and 1320(B) may be connected to augmented-reality system 1300 via a wireless connection (e.g., a BLUETOOTH connection). In still other embodiments, acoustic transducers 1320(A) and 1320(B) may not be used at all in conjunction with augmented-reality system 1300.

Acoustic transducers 1320 on frame 1310 may be positioned in a variety of different ways, including along the length of the temples, across the bridge, above or below display devices 1315(A) and 1315(B), or some combination thereof. Acoustic transducers 1320 may also be oriented such that the microphone array is able to detect sounds in a wide range of directions surrounding the user wearing the augmented-reality system 1300. In some embodiments, an optimization process may be performed during manufacturing of augmented-reality system 1300 to determine relative positioning of each acoustic transducer 1320 in the microphone array.

In some examples, augmented-reality system 1300 may include or be connected to an external device (e.g., a paired device), such as neckband 1305. Neckband 1305 generally represents any type or form of paired device. Thus, the following discussion of neckband 1305 may also apply to various other paired devices, such as charging cases, smart watches, smart phones, wrist bands, other wearable devices, hand-held controllers, tablet computers, laptop computers, other external compute devices, etc.

As shown, neckband 1305 may be coupled to eyewear device 1302 via one or more connectors. The connectors may be wired or wireless and may include electrical and/or non-electrical (e.g., structural) components. In some cases, eyewear device 1302 and neckband 1305 may operate independently without any wired or wireless connection between them. While FIG. 13 illustrates the components of eyewear device 1302 and neckband 1305 in example locations on eyewear device 1302 and neckband 1305, the components may be located elsewhere and/or distributed differently on eyewear device 1302 and/or neckband 1305. In some embodiments, the components of eyewear device 1302 and neckband 1305 may be located on one or more additional peripheral devices paired with eyewear device 1302, neckband 1305, or some combination thereof.

Pairing external devices, such as neckband 1305, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1300 may be provided by a paired device or shared between a paired device and an eyewear device, thus reducing the weight, heat profile, and form factor of the eyewear device overall while still retaining desired functionality. For example, neckband 1305 may allow components that would otherwise be included on an eyewear device to be included in neckband 1305 since users may tolerate a heavier weight load on their shoulders than they would tolerate on their heads. Neckband 1305 may also have a larger surface area over which to diffuse and disperse heat to the ambient environment. Thus, neckband 1305 may allow for greater battery and computation capacity than might otherwise have been possible on a stand-alone eyewear device. Since weight carried in neckband 1305 may be less invasive to a user than weight carried in eyewear device 1302, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1305 may be communicatively coupled with eyewear device 1302 and/or to other devices. These other devices may provide certain functions (e.g., tracking, localizing, depth mapping, processing, storage, etc.) to augmented-reality system 1300. In the embodiment of FIG. 13, neckband 1305 may include two acoustic transducers (e.g., 1320(I) and 1320(J)) that are part of the microphone array (or potentially form their own microphone subarray). Neckband 1305 may also include a controller 1325 and a power source 1335.

Acoustic transducers 1320(I) and 1320(J) of neckband 1305 may be configured to detect sound and convert the detected sound into an electronic format (analog or digital). In the embodiment of FIG. 13, acoustic transducers 1320(I) and 1320(J) may be positioned on neckband 1305, thereby increasing the distance between the neckband acoustic transducers 1320(I) and 1320(J) and other acoustic transducers 1320 positioned on eyewear device 1302. In some cases, increasing the distance between acoustic transducers 1320 of the microphone array may improve the accuracy of beamforming performed via the microphone array. For example, if a sound is detected by acoustic transducers 1320(C) and 1320(D) and the distance between acoustic transducers 1320(C) and 1320(D) is greater than, e.g., the distance between acoustic transducers 1320(D) and 1320(E), the determined source location of the detected sound may be more accurate than if the sound had been detected by acoustic transducers 1320(D) and 1320(E).

Controller 1325 of neckband 1305 may process information generated by the sensors on neckband 1305 and/or augmented-reality system 1300. For example, controller 1325 may process information from the microphone array that describes sounds detected by the microphone array. For each detected sound, controller 1325 may perform a direction-of-arrival (DOA) estimation to estimate a direction from which the detected sound arrived at the microphone array. As the microphone array detects sounds, controller 1325 may populate an audio data set with the information. In embodiments in which augmented-reality system 1300 includes an inertial measurement unit, controller 1325 may compute all inertial and spatial calculations from the IMU located on eyewear device 1302. A connector may convey information between augmented-reality system 1300 and neckband 1305 and between augmented-reality system 1300 and controller 1325. The information may be in the form of optical data, electrical data, wireless data, or any other transmittable data form. Moving the processing of information generated by augmented-reality system 1300 to neckband 1305 may reduce weight and heat in eyewear device 1302, making it more comfortable to the user.

Power source 1335 in neckband 1305 may provide power to eyewear device 1302 and/or to neckband 1305. Power source 1335 may include, without limitation, lithium ion batteries, lithium-polymer batteries, primary lithium batteries, alkaline batteries, or any other form of power storage. In some cases, power source 1335 may be a wired power source. Including power source 1335 on neckband 1305 instead of on eyewear device 1302 may help better distribute the weight and heat generated by power source 1335.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1400 in FIG. 14, that mostly or completely covers a user's field of view. Virtual-reality system 1400 may include a front rigid body 1402 and a band 1404 shaped to fit around a user's head. Virtual-reality system 1400 may also include output audio transducers 1406(A) and 1406(B). Furthermore, while not shown in FIG. 14, front rigid body 1402 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 1300 and/or virtual-reality system 1400 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1300 and/or virtual-reality system 1400 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1300 and/or virtual-reality system 1400 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a quantum well that comprises or includes indium gallium nitride include embodiments where a quantum well consists essentially of indium gallium nitride and embodiments where a quantum well consists of indium gallium nitride.

What is claimed is:

1. A system comprising:
a source configured to emit partially spatially coherent light; and
a metasurface located proximate to a light emitting surface of the source, wherein the metasurface is configured to modify at least one property of the emitted light.

2. The system of claim 1, wherein the source comprises a multi-mode laser, a vertical cavity surface emitting laser (VCSEL), or a light emitting diode (LED).

3. The system of claim 1, wherein the metasurface comprises a multiplexed 2D array of coherent metasurfaces.

4. The system of claim 1, wherein the metasurface comprises a multilayer architecture.

5. The system of claim 1, comprising a plurality of coherent metasurfaces, wherein each coherent metasurface is configured to modify the at least one property of a respective selected mode of the emitted light.

6. The system of claim 1, wherein the metasurface comprises a dielectric material.

7. The system of claim 1, wherein the metasurface comprises an electrically conductive material.

8. The system of claim 1, wherein the metasurface is configured to be transformed using an input selected from the group consisting of applied voltage, temperature, and mechanical force.

9. The system of claim 1, wherein a distance between the light emitting surface and the metasurface is less than approximately 10 micrometers.

10. The system of claim 1, wherein a lateral dimension of the light emitting surface is less than approximately 50 micrometers.

11. The system of claim 1, wherein the at least one property is selected from the group consisting of phase, amplitude, directionality, far field profile, and polarization.

12. A method comprising:
emitting partially spatially coherent light from a source; and
passing the emitted light through a metasurface located proximate to the source, wherein the metasurface modifies at least one property of the emitted light.

13. The method of claim 12, wherein the emitted light is pulsed.

14. The method of claim 12, wherein the at least one property is selected from the group consisting of phase, amplitude, directionality, far field profile, and polarization.

15. A device comprising:
a light source configured to emit partially spatially coherent light; and
a plurality of coherent metasurfaces located proximate to a light emitting surface of the light source.

16. The device of claim 15, wherein each coherent metasurface is configured to modify at least one property of a respective mode of the emitted light.

17. The device of claim 15, wherein the partially spatially coherent light is decomposable into at least two discrete coherent modes such that a respective coherent metasurface is configured to modify at least one property of the emitted light for each discrete coherent mode.

18. The device of claim 15, wherein the partially spatially coherent light has at least two discrete coherent modes identifiable by coherent mode decomposition that each provide at least 5% of the total power of the partially spatially coherent light source.

19. The device of claim 15, wherein the partially spatially coherent light has 20 or fewer discrete coherent modes that cumulatively provide at least 50% of the total power of the partially spatially coherent light source.

20. The device of claim 15, wherein the partially spatially coherent light has no more than 10 discrete coherent modes that each provide at least 5% of the total power of the partially spatially coherent light source.
